(19) United States
(12) Patent Application Publication
(10) Pub. No.: US 2010/0274696 A1
(43) Pub. Date: Oct. 28, 2010

(54) Digital media content sharing system

(76) Inventors: Mark H. Krietzman, Palos Verdes Estates, CA (US); Damon L. Cusato, Malibu, CA (US)

Correspondence Address: M. Krietzman, P.O. Box 3185, Palos Verdes, CA, 90274, US

(21) Appl. No.: 12/799,570

(22) Filed: Apr. 26, 2010

Related U.S. Application Data
(60) Provisional application No. 61/214,693, filed on Apr. 27, 2009.
(60) Provisional application No. 61/269,103, filed on Jun. 18, 2009.

(51) Int. Cl. H04N 7/16; G06Q 30/00; G06Q 50/00

(52) U.S. Cl. 705/34; 725/152

(57) ABSTRACT

A digital media sharing system (“DMSS”) for receiving digital media data (“DMD”) produced by a media device is described. The DMSS may include a network, a first set-top box in signal communication with the network, a first rendering device in signal communication with the set-top box and the network, and a storage device in signal communication with the set-top box and the network.

### RELATED APPLICATIONS

This application claims priority to U.S. Provisional Patent Application Ser. No. 61/214,693, filed on Apr. 27, 2009, titled “System and method to prepare and deliver shared digital media content” to inventors M. Krietzman & D. Cusato and Ser. No. 61/269,103, filed on Jun. 18, 2009, titled “Method, System And Infrastructure For Sharing Digital Media Content,” to inventors M. Krietzman & D. Cusato, both of which are herein incorporated in their entirety, as if fully set forth herein, by reference in this application.

### BACKGROUND

1. Field

This disclosure relates generally to communication systems, and in particular to a method and system for sharing digital media content through a communication infrastructure.

2. Art

At present, the growth of telecommunication networks has allowed a growing number of people to communicate with each other in many different ways. These telecommunication networks have allowed people to communicate in ways that vary from voice telephony to data and media sharing. Global communication networks such as the Internet have produced communication options such as email, file transfer protocol (“ftp”), personal websites, online forums, chat services, peer-to-peer services, instant messenger services (such as messenger services provided by Yahoo®, Microsoft®, Google®, etc), streaming media services (such as Youtube®), voice-over IP (“VoIP”)(such as Skype®, Vonage®, etc), Internet video conferencing, social networking services (such as Twitter®, Linkedin®, Facebook®, etc.), etc. Other telecommunication networks such as some of the cellular telecommunication networks have also increased the ways that their users can communicate with each other (such as text messaging, media sharing services, etc.) and with external communication networks such as the Internet. As a result, at present, the sharing of digital media has become a growing cultural trend both on the Internet and cellular telephone networks.

Unfortunately, at present, these network sharing services require that a user has access to the Internet or advanced cellular network such as IMT-2000 (generally known as 3G network), the knowledge on how to utilize these services which at times can be complex, the ability to pay for the services that are subscription based (beyond the price of paying for Internet access or cellular service), and access to electronic devices capable of accessing these services on the Internet and/or advanced cellular network such as, for example, a personal computer (“PC”), advanced cellular telephone, personal digital assistant (“PDA”), personal communication service (“PCS”) device, etc. In general, video sharing websites require that the user in capable of uploading their video to a PC that is capable of rendering the video to produce a digital video file that is in a container file type that is compatible with the video sharing website such as, for example, .AVI, .MKV, .MOV, .MP4, .DivX, .FLV, and .OGG. Additionally, these types of video sharing websites require that the user have an expensive broadband Internet connection to upload the rendered digital video to the video sharing website. Moreover, these types of video sharing websites also do not allow the user to privately save or archive their videos that may be optionally and selectively shared with a small list of other users.

As an example, in order to upload a video to a video sharing service such as Youtube®, a user must typically first capture the video with a video device such as webcam or video camera (such as camcorder or digital camera with video capture capability), upload or capture the video to a computer, and then use the computer to upload the captured video to the video sharing service via the Internet. If the video needs to converted to a format compatible with the video sharing service, the computer must have software capable of converting the video to required format. Additionally, if the video needs to be captured such as in the case of a non-digital video device, the computer must have a video capture module (such as a video capture card) and video capture software capable of capturing the video and saving the captured video into a digital video format capable of being uploaded to the video sharing service. Additionally, because of the open nature of the Internet many of these services are unsecure allowing others to access or intercept a users uploaded media. Moreover, once uploaded, only other users, who are as technically sophisticated and also possess the required hardware (such as, for example, a personal computer) and potentially subscribe to the same service, are capable of viewing and/or downloading these video files.

As such, there is a need for a system and method for sharing digital media content through a communication infrastructure that is secure and does not have any of the drawbacks of the prior art services.

### DESCRIPTION

A digital media sharing system (“DMSS”) for receiving digital media data (“DMD”) produced by a media device is described. The DMSS may include a network, a first set-top box in signal communication with the network, a first rendering device in signal communication with the set-top box and the network, and a storage device in signal communication with the set-top box and the network. The first set-top box may be configured to receive the DMD from the media device and the rendering device may be configured to render the received DMD. The storage device may be configured to store the rendered DMD.

In some exemplary implementations, and one or more aspects associated therewith, set forth is a DMSS for receiving digital media data produced by a media device, the DMSS including a network; a first set-top box in signal communication with the network, wherein the first set-top box is configured to receive the digital media data from the media device; a first rendering device in signal communication with the set-top box and the network, wherein the rendering device is configured to render the received digital media data; a storage device in signal communication with the set-top box and the network, wherein the storage device is configured to store the rendered digital media data; and the network is a cable communication network that is in signal communication with a plurality of set-top boxes.

In some exemplary implementations, and one or more aspects associated therewith, is set forth a DMSS for receiving digital media data produced by a media device, the DMSS including a network; a first set-top box in signal communication with the network, wherein the first set-top box is configured to receive the digital media data from the media device; a first rendering device in signal communication with the set-top box and the network, wherein the rendering device is configured to render the received digital media data; a storage device in signal communication with the set-top box and the network, wherein the storage device is configured to store the rendered digital media data; the network is a cable communication network that is in signal communication with a plurality of set-top boxes; and there is at least one server in signal communication with the cable communication network and wherein the first rendering device is external to the first set-top box and is in signal communication with the server. In some implementations the storage device is external to the first set-top box and is in signal communication with the server. In some implementations there is a second set-top box of the plurality of set-top boxes, wherein the second set-top box is configured to receive the rendered digital media data from the storage device. In some implementations a second rendering device located within a second set-top box of the plurality of set-top boxes. In some aspects the storage device is external to the first set-top box and is in signal communication with the server. In some implementations the second set-top box is configured to receive the rendered digital media data from the storage device. In some implementations a third set-top box of the plurality of set-top boxes, wherein the third set-top box is in signal communication with the network, and wherein the third set-top box is configured to receive the rendered digital media data from the storage device.

In some exemplary implementations, and one or more aspects associated therewith, set forth is a method for sharing digital media data produced by a media device over a network having a plurality of set-top boxes, the method including; receiving the digital media data at a first set-top box of the plurality of set-top boxes; rendering the received digital media data; storing the rendered digital media data on a storage device; and, the network is a cable communication network that is in signal communication with the plurality of set-top boxes. In some implementations storing includes storing the rendered digital media data on a storage device located within the first set-top box and rendering includes rendering the received digital media data in a file format that is usable by the storage device. In some implementations an accessible menu that is displayed on a display in signal communication with the first set-top box is produced, wherein the accessible menu displays a confirmation of the storage of the rendered digital media data. In some implementations the server is queried for at least one file format usable by the targeted storage device.

In some implementations receiving the rendered digital media data from the storage device is at least one second set-top box from the plurality of set-top boxes. In some implementations rendering the received digital media data is within at least one of the first set-top box and a second set-top box of the plurality of set-top boxes.

Other devices, apparatus, systems, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### FIGURES

The disclosure may be better understood by referring to the following figures. The components in the figures are not necessarily to scale, emphasis instead being placed upon illustrating the principles of the disclosure. In the figures, like reference numerals designate corresponding parts throughout the different views. All callouts in any appendices and/or figures are hereby incorporated by this reference.

FIG. 1 is a system block diagram of an example of an implementation of digital media sharing system (“DMSS”) for receiving digital media data produced by a media device, in accordance with the disclosure.

FIG. 2 is a block diagram of an example of an implementation of utilizing the DMSS of FIG. 1 for capturing and rendering recorded video produced a the media device.

FIG. 3 shows a flow chart illustrating an example process performed by the DMSS described in FIGS. 1 and 2 in accordance with the disclosure.

FIG. 4 shows a block diagram of an example of an implementation of DMSS to share DMD between STBs, mobile devices, and archives in accordance with the disclosure.

FIGS. 5 through 16 show examples of screen shots of a user interface to some aspects of the disclosure.

All descriptions and callouts in the Figures are hereby incorporated by this reference as if fully set forth herein.

### FURTHER DESCRIPTION

In the following description of examples of implementations, reference is made to the accompanying drawings that form a part hereof, and which show, by way of illustration, specific implementations of the present disclosure that may be utilized. Other implementations may be utilized and structural changes may be made without departing from the scope of the present disclosure.

In general, a digital media sharing system (“DMSS”) for receiving digital media data produced by a media device is disclosed. The DMSS may share the digital media data (“DMD”) with a number of users and/or store the DMD in varying types of storage devices. In general, the DMSS may include a network, a first set-top box (“STB”), a first rendering device, and a storage device. The first STB may be in signal communication with the network. The first rendering device may be in signal communication with the STB and the network. The storage device may also be in signal communication with the STB and the network. The first STB is configured to receive the DMD from the media device and the rendering device is configured to render the received DMD. The storage device is configured to store the rendered DMD. Moreover, in addition to the first STB, the DMSS may also include other STBs in signal communication with the network. As an example of operation, the DMSS may perform a method that includes receiving the DMD at the first STB of the plurality of STBs, rendering the received DMD, and then storing the rendered DMD on a storage device.

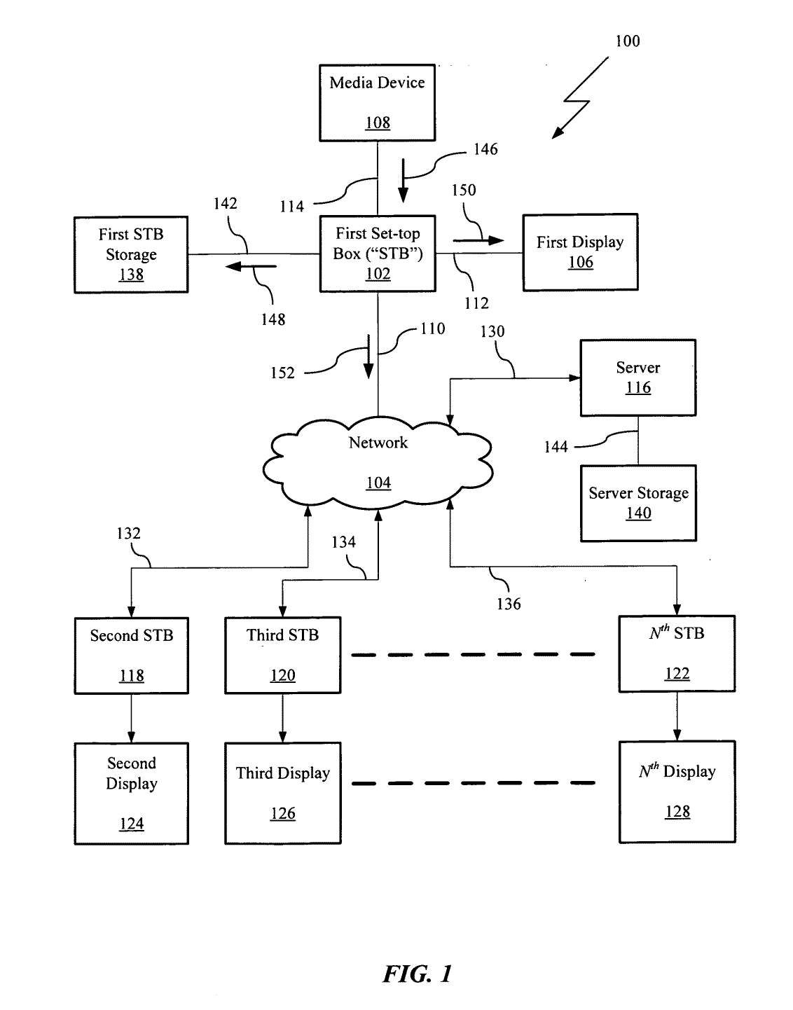

Turning to FIG. 1, a system block diagram is shown of an example of an implementation of DMSS 100 in accordance with the disclosure. The DMSS 100 may include a first STB 102 in signal communication with a network 104, display 106, and media device 108 via signal paths 110, 112, and 114, respectively. The DMSS 100 may also include a server 116, a second STB 118, second display 120, a third STB 122, third display 124, an N^{th} STB 126, and an N^{th} display 128. The network 104 may be in signal communication with the server 116, second STB 118, third STB 122, and the N^{th} STB 126 via signal paths 130, 132, 134, and 136, respectively. The first STB 102 may also be in signal communication with a first STB storage 138 and the server may be in signal communication with a server storage 140 via signal paths 142 and 144, respectively. Similarly each STB from the second STB 118 to the N^{th} STB 122 may also have an associated STB storage (not shown) in signal path with each corresponding STB.

It is appreciated by those skilled in the art that the circuits, components, modules, and/or devices of the DMSS 100 are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic waveguides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

As an example, the first STB 102, second STB 118, third STB 120, and N^{th} STB 122 may all be typical STBs utilized either by a cable television provider (“CTP”) such as, for example, Cox Communication, Time Warner Cable, Comcast, etc., a satellite television provider (“STP”) such as, for example, DISH Network®, DIRECTV®, etc., or other type of network television provider (such as television visa DSL) that requires that end user use an STB to receive television content (analog, digital, or both) from a propriety communication network that can be displayed on a display in signal communication with the STB. In the example of a CTP, the STB is generally known as a “cable box.” The STB may be any device capable of receiving television programming with one or more video tuners and processor(s) and a device address. Typically, STBs include storage capacity (such as first STB storage 138) for storing shared DMD and/or for buffering shared DMD. Generally, STBs are devices that have assigned MAC addresses, IP addresses, access IDs, and serial numbers that are specific to the STB and are a form of identity information to the CTP or STP. The STBs may also include a digital video recorder (“DVR”).

The media device 108 is a detachable device that may be any type of video device including, for example, a video camera (such as an analog or digital camcorder), digital camera with video capability, a video enable cellular telephone, etc.

Each transforming of DMD from one device or form to another device or form is an opportunity for the CTP or STP to form a new revenue stream either through a per event charge or recurring charge for access to the portions of the hardware and software within the CTP or STP infrastructure. Media device(s) 108 well suited to mate, merge or connect or otherwise interface with said CTP or STP for optimal rendering and/or transfer provide additional opportunity for said CTP or STP to derive revenue streams from per use, recurring, sales, leasing or rental.

The network 104 may be any propriety communication network such as for example, a CTP network and/or STP network. The network 104 may include access to travel through non-propriety communication networks such as the Internet or cellular telephone networks.

The first display 106, second display 124, third display 126, and N^{th} display 128 may be any generally know video display that is capable of display visual programming and information produced by the corresponding STB 102, 118, 120, and 122, respectively. Examples of these types of video displays include analog and/or digital televisions, display monitors, computer monitors, etc.

The server 116 may be any server or combination of servers utilized by the CTP or STP for accessing and/or controlling the network 104. In the case of a CTP and/or STP, the server 116 may include the communication and processing equipment utilized by the CTP and/or STP to generate, control, and/or save DMD on the DMSS 100. Said server or any portion thereof may be targeted for use for a particular storage task.

The first STB storage 138, server storage 140, and other storage devices (not shown) corresponding to the other STBs 118, 120, and 122, may be memory devices capable of storing DMD. The STB storage 138 (and the storage of the other STBs 118, 120, and 122) may be memory devices that may be either internal to the first STB 102 and other corresponding STBs 118, 120, and 122, or external based on the preference of the user of the corresponding STB and the capabilities offered by the respective CTP and/or STP. Examples of the these types of storage may include, for example, computer hard-drives and/or RAM memory. In the case of the first STB storage 138, it may be a hard-drive located internal to the first STB 102 or it could optionally be an external storage unit such as an external hard-drive. In the case of the server 116, the server storage 140 may also be an internal hard-drive to the server 116, external hard-drive, or it could be one or more storage servers (not shown) that include multiple hard-drives each.

The first STB 102, second STB 118, third STB 120, N^{th} STB 122, and server 116 may each have processor (not shown) capable of processing (such, as for example, capturing, converting, and/or rendering) of receiving video data from the media device 108 and converting it to DMD and/or converting the DMD into another format for video processing or optimized for storage on the first STB storage 138, server storage 140, other storage devices, or combination of storage devices. The processor may act as a rendering device that is configured to render any received video from the media device 108 to produce the DMD. The processor may also act a parallel processing rendering device wherein a processor for a given device (such as the first STB 102) may act in parallel with the processor (not shown) of the server 116 and/or other processors (not shown) of the other STBs 118, 120, and 122 to render the video or DMD quicker than would be possible by just one single processor. The processor may be any general purpose processor such as for example an central processor unit (“CPU”), an application specific integrated chip (“ASIC”), digital signal processor (“DSP”), reduced instruction set (“RISC”) processor, microprocessor, or other similar devices.

As an example of operation, the DMSS 100 may perform a method that includes receiving the DMD at the first STB 102 of the plurality of STBs, rendering the received DMD, and then storing the rendered DMD on a storage device. The storage device may be the first STB storage 138, server storage 140, a storage device corresponding to the other STBs, or a combination of these.

More specifically, if a user captures video with the media device 108 (such as, for example, recording video with a video camera) and then connects the media device 108 to the first STB 102 via the signal path 114 (which may be via a universal serial bus (“USB”), HDMI, firewire®, eSATA, IEEE 802.11, Bluetooth, Ethernet, LAN, white space device, or other type of wired or wireless connection), the user can upload his/her recorded video to the first STB 102. The recorded video uploaded via an input video signal 146 that may be analog or digital based on the type of device utilized as the media device 108. The input video signal 146 is received by the first STB 102 which may process the input video signal 146 to produce a DMD signal which may be sent 148 along signal path 142 to be stored in the first STB storage 138 and/or sent 150 along signal path 112 to be displayed on the first display 106. Alternatively, the DMD may be sent 152 from the first STB 102 along signal path 110 through the network 104 to either the server 116, one of more STBs (such as 118, 120, and 122), or combination of either server 116 and STBs or multiple STBs based on the utilization of the other processors in the server 116 or other STBs 118, 120, and 122.

In general, the first STB 102 includes software with drivers which are capable of auto-detecting the type of device that the media device 108 is when it is connected to the first STB 102. The STB 102 may include a driver database with different drivers corresponding to different media devices. Once the proper driver is installed in the first STB 102, the first STB 102 is able to copy or capture video 146 received from the media device 108. The first STB 102 is then configured to encode the video 146 in real-time utilizing a tuner or other video specific device such as video encoder, processor or chip designed for video capture. It is appreciated that the encoding can be shared between the first STB 102, the other STBs 118, 120, and 122 and/or the server 116 based on usage of the different processors in the different devices. Once the encoding have been completed, the first STB 108 is configured to store the DMD on the first STB storage 138 and/or remote storage such as server storage 140 and/or other storage devices on the other STBs 118, 120, and 122. To connect to a remote storage, the first STB 108 may utilize network security credential such as, for example, peer name, password and MAC address to authentic peer.

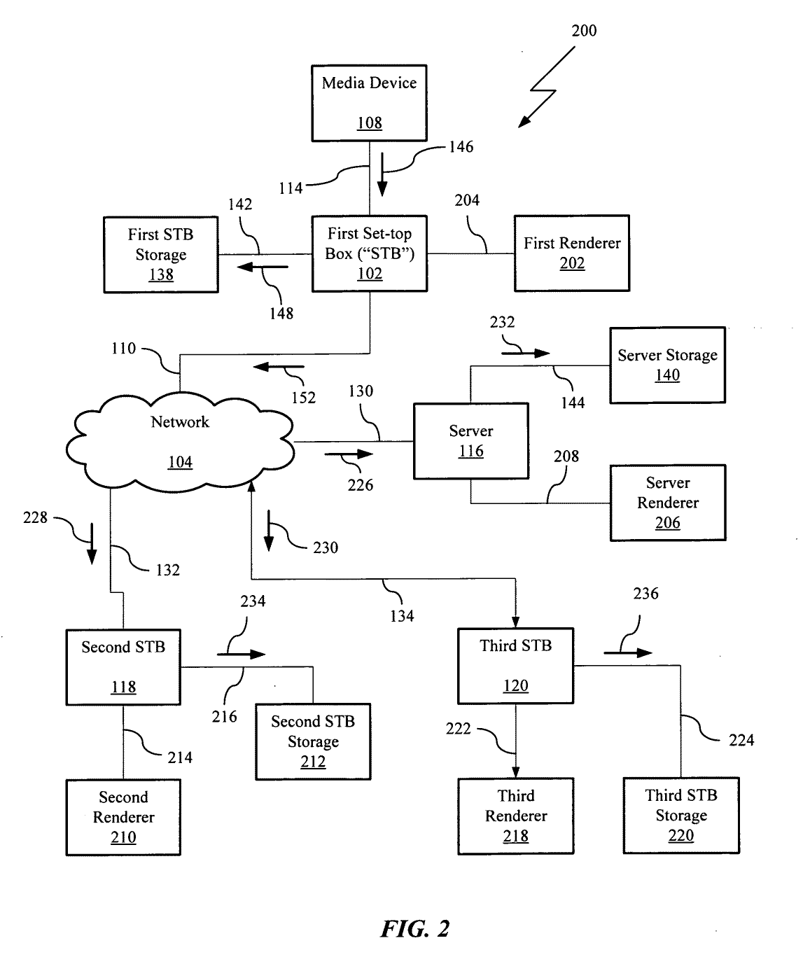

In FIG. 2, a block diagram is shown of an example of an implementation of utilizing the DMSS 200 for capturing and rendering recorded video 146 produced by the media device 108. In this example, the first STB 102 may include a first renderer 202 that is in signal communication with the first STB 102 via signal path 204. The first renderer 202 may be module, circuit, component, and/or device located internal to the first STB 102 or may be an external device. The server 116 may also include a server renderer 206 in signal communication with the server 116 via signal path 208. Similar to the first renderer 202, the server renderer 206 may be module, circuit, component, and/or device located internal to the server 116 or may be an external device. The second STB 118 may include a second renderer 206 and a second STB storage 212 in signal communication with the second STB 118 via signal paths 214 and 216, respectively. Similar to the first renderer 202, the second renderer 206 may be module, circuit, component, and/or device located internal to the second STB 118 or may be an external device. Similar to first STB storage 138, the second STB storage 118 may be a memory device capable of storing the DMD. The second STB 118 may be a memory device that may be either internal to the second STB storage 118 or external based on the preference of the user of the second STB storage 118 and the capabilities offered by the respective CTP and/or STP. Examples of the second STB storage 118 may include, for example, computer hard-drives and/or RAM memory, which may be a hard-drive located internal to the second STB storage 118 or it could optionally be an external storage unit such as an external hard-drive.

Similar to the second STB 118, the third STB 120 may include a third renderer 218 and a third STB storage 220 in signal communication with the third STB 120 via signal paths 222 and 224, respectively. Similar to the first renderer 202, the third renderer 218 may be module, circuit, component, and/or device located internal to the third STB 120 or may be an external device. Similar to first STB storage 138, the third STB 120 may be a memory device capable of storing the DMD. The third STB 120 may be a memory device that may be either internal to the third STB 120 or external based on the preference of the user of the third STB 120 and the capabilities offered by the respective CTP and/or STP. Examples of the third STB 120 may include, for example, computer hard-drives and/or RAM memory, which may be a hard-drive located internal to the third STB 120 or it could optionally be an external storage unit such as an external hard-drive.

In an example of operation, a user of the first STB 102 may detachably connect a media device 108 (such as a camcorder, digital camera with video capability, cellular telephone with video capability, etc.) with recorder video to the first STB 102. As stated earlier, once connected the media device 108 may be in signal communication with the first STB 102 via the detachable connected signal path 114, which may be via a USB, HDMI, firewire®, eSATA, IEEE 802.11, Bluetooth®, Ethernet, LAN, white space device, or other type of wired or wireless connection. The user of the first STB 102 can then upload his/her recorded video to the first STB 102 from the media device 108 via the input video signal 146, which may be an analog or digital video signal based on the type of device utilized as the media device 108. The input video signal 146 is received by the first STB 102 which may process the input video signal 146 to produce a DMD signal which may be sent 148 along signal path 142 to the first STB storage 138 for storage at the first STB 102 and/or sent 152 and 226 from the first STB 102 along signal path 110 through the network 104 and signal path 130 to the server 116. Alternatively, the DMD signal may be sent 152 and 228 from the first STB 102 along signal path 110 through the network 104 and signal path 132 to the second STB 118; or the DMD signal may be sent 152 and 230 from the first STB 102 along signal path 110 through the network 104 and signal path 134 to the third STB 120. The chosen path for the DMD signal may determined by a controller (not shown) in either the first STB 102 or server 116 based on system resources of the DMSS 100. The controller may be a microprocessor, microcontroller, processor, DSP, ASIC, RISC processor, or other type of similar processor. The controller may be part of or in signal communication with a processor (not shown) located at either first STB 102 or server 116.

Storage of Digital Media Data within the Network

Based on the system resources of the DMSS 100, if the controller determines that the DMD signal is to be processed exclusively within the first STB 102, the first STB 102 receives the input video signal 146 from the media device 108 and processes it via the first renderer 202. The first renderer 202 may first capture and convert the input video signal 146 from an analog video signal to a digital video signal based on whether the media device 108 is an analog video device. If the media device 108 is a digital device, then the first renderer 202 does not have to capture and convert the input video signal 146 except for possibly converting the input video signal 146 from the digital format utilized by the media device 108 to another digital format more suitable for processing and storing by the first STB 102. The digital video signal may then be rendered by the first renderer 202 to produce the DMD signal 148 which may be passed to the first STB storage 138 via signal path 142. In this manner the first STB storage 138 may act as a local archive for DMD that is uploaded by the user utilizing the media device 108.

If the controller determines, based on the system resources of the DMSS 100, that the DMD signal is to processed by the first STB 102 but stored on the server storage 140, the first STB 102 receives the input video signal 146 from the media device 108 and processes it via the first renderer 202. The first renderer 202 may first capture and convert the input video signal 146 from an analog video signal to a digital video signal based on whether the media device 108 is an analog video device. Again, if the media device 108 is a digital device, then the first renderer 202 does not have to capture and convert the input video signal 146 except for possibly converting the input video signal 146 from the digital format utilized by the media device 108 to another digital format more suitable for processing and storing by the first STB 102 and/or server 116. The digital video signal may then be rendered by the first renderer 202 to produce the DMD signal 152, 226, and 232 which may be passed to the server storage 140 via signal paths 110, 130, and 144, network 104, and server 116. In this manner the server storage 140 may act as a remote archive for the DMD that is uploaded by the user utilizing the media device 108. If a specific remote archive provider of archive server is particularly identified for an archive task that server may be referred to as targeted.

If the controller determines, based on the system resources of the DMSS 100, that the DMD signal is to processed by the first STB 102 but stored on the second STB storage 212, the first STB 102 receives the input video signal 146 from the media device 108 and processes it via the first renderer 202. The first renderer 202 may first capture and convert the input video signal 146 from an analog video signal to a digital video signal based on whether the media device 108 is an analog video device. Again, if the media device 108 is a digital device, then the first renderer 202 does not have to capture and convert the input video signal 146 except for possibly converting the input video signal 146 from the digital format utilized by the media device 108 to another digital format more suitable for processing and storing by the first STB 102 and/or second STB 118. The digital video signal may then be rendered by the first renderer 202 to produce the DMD signal 152, 228, and 234 which may be passed to the second STB storage 212 via signal paths 110, 132, and 216, network 104, and second STB 118. In this manner the second STB storage 212 may act as a remote archive for the DMD that is uploaded by the user utilizing the media device 108.

Similarly, if the controller determines, based on the system resources of the DMSS 100, that the DMD signal is to processed by the first STB 102 but stored on the third STB storage 220, the first STB 102 receives the input video signal 146 from the media device 108 and processes it via the first renderer 202. The first renderer 202 may first capture and convert the input video signal 146 from an analog video signal to a digital video signal based on whether the media device 108 is an analog video device. Again, if the media device 108 is a digital device, then the first renderer 202 does not have to capture and convert the input video signal 146 except for possibly converting the input video signal 146 from the digital format utilized by the media device 108 to another digital, format more suitable for processing and storing by the first STB 102 and/or third STB storage 220. The digital video signal may then be rendered by the first renderer 202 to produce the DMD signal 152, 230, and 236 which may be passed to the third STB storage 220 via signal paths 110, 134, and 224, network 104, and third STB 120. In this manner the third STB 120 may act as a remote archive for the DMD that is uploaded by the user utilizing the media device 108.

Rendering Digital Media Data within the Network

i. Rendering at the Server Renderer

Based on the system resources of the DMSS 100, if the controller determines that the DMD signal is to be processed external to the first STB 102 at the server renderer 206, the first STB 102 receives the input video signal 146 from the media device 108 and processes it via the first renderer 202. The first renderer 202 may first capture and convert the input video signal 146 from an analog video signal to a digital video signal based on whether the media device 108 is an analog video device. If the media device 108 is a digital device, then the first renderer 202 does not have to capture and convert the input video signal 146 except for possibly converting the input video signal 146 from the digital format utilized by the media device 108 to another digital format more suitable for processing by the server renderer 206. The first STB 102 then sends the digital video signal to the server renderer 206 via signal paths 110, 130, and 208 and through the network 104 and server 116. The digital video signal may then be rendered by the server renderer 206 to produce the DMD signal 232 which may be passed to the server storage 140 via signal path 144 or back to the first STB 102 and stored via the first STB storage 138. In this manner the server renderer 206 acts as a remote processor capable of processing the digital video signal with processing power that is typically greater than that of the processor of the first renderer 202. In this example, the first STB storage 138 may act as a local archive for DMD that is processed by the server renderer 206 or the server storage 140 may act as a remote archive for DMD that is processed by the server renderer 206.

ii. Rendering at the Second STB

If, instead, the controller determines that the DMD signal is to be processed external to the first STB 102 at the second STB renderer 212, the first STB 102 receives the input video signal 146 from the media device 108 and processes it via the first renderer 202. The first renderer 202 may first capture and convert the input video signal 146 from an analog video signal to a digital video signal based on whether the media device 108 is an analog video device. If the media device 108 is a digital device, then the first renderer 202 does not have to capture and convert the input video signal 146 except for possibly converting the input video signal 146 from the digital format utilized by the media device 108 to another digital format more suitable for processing by the server renderer 206. The first STB 102 then sends the digital video signal to the second STB renderer 212 via signal paths 110, 132, and 216 and through the network 104 and second STB 118. The digital video signal may then be rendered by the second STB renderer 212 to produce the DMD signal 234 which may be passed to the second STB storage 212 via signal path 216 or back to the first STB 102 and stored via the first STB storage 138. Similarly to the previous example, in this manner the second STB renderer 212 acts as a remote processor capable of processing the digital video signal. In this example, the first STB storage 138 may act as a local archive for DMD that is processed by the second STB renderer 212 or the second STB storage 212 may act as a remote archive for DMD that is processed by the second STB renderer 212.

iii. Rendering in Parallel Utilizing Multiple Renderers on the Network

Alternatively, if the controller determines that the DMD signal is to be processed in parallel utilizing the first renderer 202 and one or more external renderers, the first STB 102 receives the input video signal 146 from the media device 108 and processes it via the first renderer 202. The first renderer 202 may first capture and convert the input video signal 146 from an analog video signal to a digital video signal based on whether the media device 108 is an analog video device. If the media device 108 is a digital device, then the first renderer 202 does not have to capture and convert the input video signal 146 except for possibly converting the input video signal 146 from the digital format utilized by the media device 108 to another digital format more suitable for processing by the plurality of renderers. Part of the digital video signal may then be rendered by the first renderer 202 to produce part of the DMD signal which may, be passed to the first STB storage 138 via signal path 142. In this manner the first STB storage 138 may act as a local archive for DMD that is uploaded by the user utilizing the media device 108.

Another part of the digital video signal may then be rendered by the second renderer 210 to produce another part of DMD signal which may be passed to the first STB storage 138 via signal paths 214, 132, 110, and 142 and through the second STB 118, network 104 and first STB 102. This second part of the DMD signal may be combined with the first part of the DMD signal to make the combined DMD signal 148. Moreover, another part of the digital video signal may then be rendered by the third renderer 218 to produce yet another part of DMD signal which may be passed to the first STB storage 138 via signal paths 222, 134, 110, and 142 and through the third STB 120, network 104 and first STB 102. This third part of the DMD signal may also be combined with the first and second parts of the DMD signal to make the combined DMD signal 148.

Additionally, another part of the digital video signal may then be rendered by the server renderer 206 to produce yet another part of DMD signal which may be passed to the first STB storage 138 via signal paths 208, 130, 110, and 142 and through the server 116, network 104 and first STB 102. This fourth part of the DMD signal may also be combined with the first, second and thirds parts of the DMD signal to make the combined DMD signal 148. Further still, another part of the digital video signal may then be rendered by a plurality of renderers at different corresponding STBs to produce more parts of DMD signal which may be passed to the first STB storage 138. These plurality of parts of the DMD signal may also be combined with the first and second parts of the DMD signal to make the combined DMD signal 148.

It is appreciated by those skilled in the art that number of external renderers utilized is based on the system resources of the DMSS 100 and available bandwidth of these renderers. It is also appreciated that while the server renderer 206 is potentially the most powerful renderer (or renderers based on the number of servers on the network), it may still be beneficial to utilize the renderers in a plurality of STBs in order to speed up any rendering tasks using known parallelization techniques.

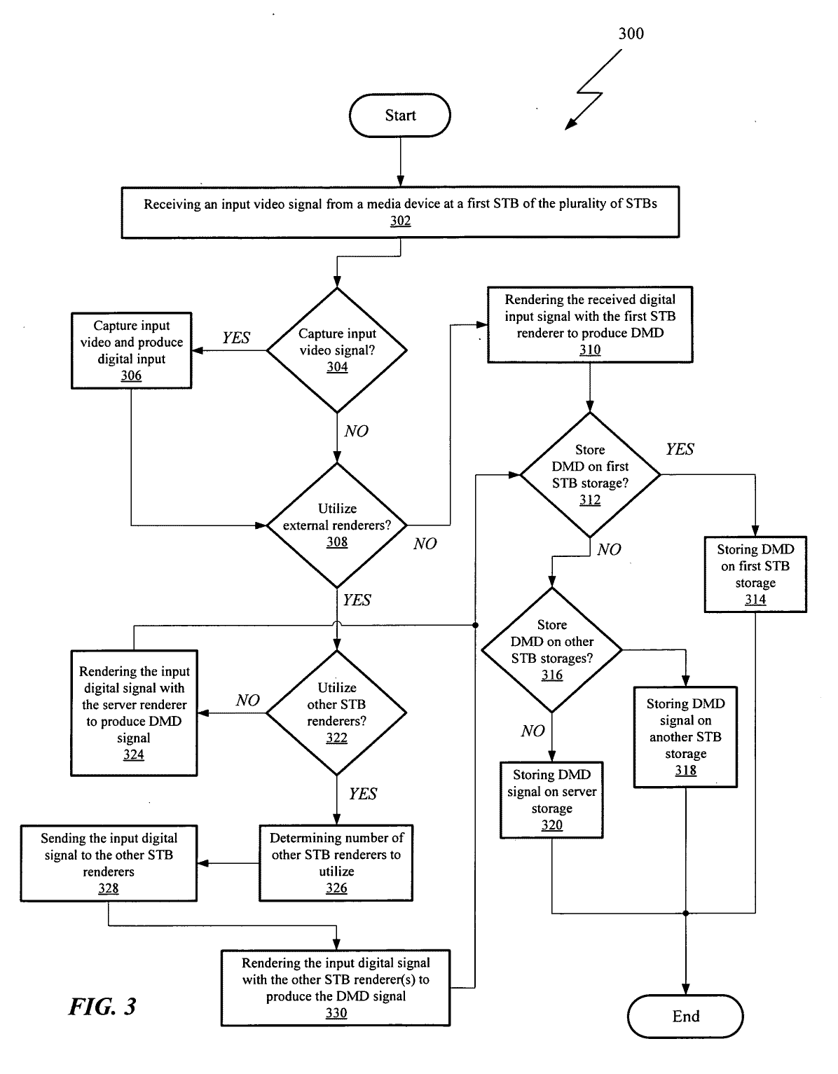

FIG. 3 shows a flow chart 300 illustrating the example process performed by the DMSS described above in accordance with the disclosure. In general, the process starts, in step 302, by receiving an input video signal from a media device at the first STB of the plurality of STBs. The first STB then determines, in step 304, if the input video signal is in a digital format capable of being procesed directly by the first STB or whether it needs to be captured with video capture so a to produce a digital input video signal capable of being processed directly by the first STB, server, or other STBs on the network. The input video signal may need to be captured if it is an analog video signal or is a digital video signal in a format that needs to be converted so as to be compatible with the first STB, server, or other STBs on the network. If the input video signal needs to be captured, the input video signal is capture to produce the digital input signal, in step 306. The process then determines, in step 308, whether to use the first renderer, an external renderer, or a combination of the first renderer and external renderers.

If the input video signal does not need to be captured, the input video signal is the digital input signal and the process continued to determination step 308. As stated earlier, the process then determines, in step 308, whether to use the first renderer, an external renderer, or a combination of the first renderer and external renderers.

If no external renderers are to be utilized the process continues to step 310. The first STB render then renders the digital input signal to produce the DMD signal. The process then continues to determination step 312, where the first STB determines whether the DMD signal is to be stored on the first STB storage or external storage. If it is determined that the DMD signal is to be stored on the first STB storage, the process continues to step 314, where the DMD signal is stored on the first STB storage, which may be either internal or external (such as, for example, connected via USB, HDMI, firewire®, eSATA, IEEE 802.11, Bluetooth®, Ethernet, LAN, white space device, or other type of wired or wireless connection) to the first STB. The process then ends.

Alternatively, if it is determined that the DMD signal is not to be stored on the first STB storage, the process continues to determination step 316. In determination step 316, if the DMD signal is to be stored on another STB storage (such as, for example, the STB storage of another user that the first user desires to send the video to), the process continues to step 318, where the DMD signal is stored on the other STB storage. If, instead, it is determined that DMD signal is to be stored on the server storage, the process continues to step 320, where the DMD signal is stored on the server storage. The process then ends.

Returning to determination step 308, if external renderers are to be utilized the process continues to determination step 322. In determination step 322, if no other STB renderers are to be utilized, the process continues to step 324, where the input digital signal is rendered with the server renderer to produce the DMD signal. The process then continues to determination step 312, where the first STB determines whether the DMD signal is to be stored on the first STB storage or external storage. If it is determined that the DMD signal is to be stored on the first STB storage, the process continues to step 314, where the DMD signal is stored on the first STB storage, which may be either internal or external to the first STB. The process then ends.

Alternatively, if it is determined that the DMD signal is not to be stored on the first STB storage, the process continues to determination step 316. In determination step 316, if the DMD signal is to be stored on another STB storage (such as, for example, the STB storage of another user that the first user desires to send the video to), the process continues to step 318, where the DMD signal is stored on the other STB storage. If, instead, it is determined that DMD signal is to be stored on the server storage, the process continues to step 320, where the DMD signal is stored on the server storage. The process then ends.

Returning to determination step 322, if another STB renderer is to be utilized, the process continues to step 326. In step 326, the number of other STB renderers are determined and their identification and locations on the network are determined. In step 328, the input digital signal is send to the other STB renders. The input digital signal is then rendered utilizing the one of more of the other STB renders to produce the DMD signal. The process then continues to determination step 312, where the first STB determines whether the DMD signal is to be stored on the first STB storage or external storage. If it is determined that the DMD signal is to be stored on the first STB storage, the process continues to step 314, where the DMD signal is stored on the first STB storage, which may be either internal or external to the first STB. The process then ends.

Alternatively, if it is determined that the DMD signal is not to be stored on the first STB storage, the process continues to determination step 316. In determination step 316, if the DMD signal is to be stored on another STB storage (such as, for example, the STB storage of another user that the first user desires to send the video to), the process continues to step 318, where the DMD signal is stored on the other STB storage. If, instead, it is determined that DMD signal is to be stored on the server storage, the process continues to step 320, where the DMD signal is stored on the server storage. The process then ends.

Sharing Digital Media Data

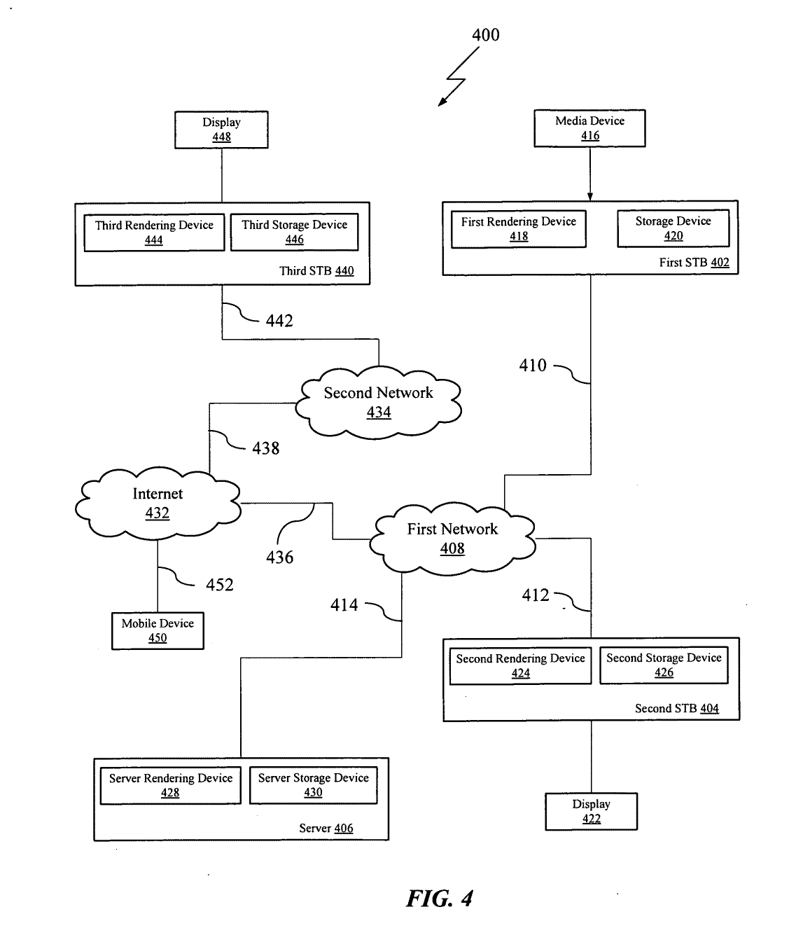

Turning back to FIG. 2, the DMSS 200 allows sharing of DMD between different users (each having a corresponding STB) in the network 104. The users and their corresponding STBs may act as peers in a peer-to-peer network. FIG. 4 shows a block diagram of an example of an implementation of DMSS 400 to share DMD between STBs, mobile devices, and archives in accordance with the disclosure. In this example, the DMSS 400 includes a first STB 402, second STB 404, server 406, and first network 408. The first STB 402, second STB 404, and server 406 may be in signal communication with the first network 408 via signal paths 410, 412, and 414, respectively. The first STB 402 may be in signal communication with a media device 416 (such as, for example, a video camera, mobile device with a built-in video camera, or other type of device) and may include a first renderer 418 and first storage device 420. Similarly, the second STB 404 may be in signal communication with a display device 422 (such as, for example, a television, video monitor, computer monitor, or other type of video device) and may include a second renderer 424 and second storage device 426. The server 406 may include a server renderer 428 and a server storage device 430. It is appreciated that while on a first STB 402 and second STB 404 are shown for illustration purposes, the first network 408 may have any plurality of STBs (not shown) in signal communication with the first network 408.

i. Sharing Digital Media Data within the Network

Within the first network 408, the STBs may share DMD. Specifically, a first user at the first STB 402 may share DMD on the first STB 402 with a second user at the second STB 404. As described above, the first user may capture video from the media device 416 at the first STB 402, which is processed to generate the DMD. Again as described above, the processing of the DMD may be accomplished by optionally utilizing the first renderer 418, the second renderer 424, the server renderer 428, other renderers (not shown) in other STBs (not shown) in signal communication with the first network 408, or any combination of these in parallel. Additionally, the DMD may be stored at the first storage device 420 and/or the server storage device 430.

The first user may allow the second user through the second STB 404 to have access to the DMD stored on the first storage device 420 and/or server storage device 430, which may then be displayed on the display device 422. The first user may also allow other STBs (not shown) on the first network 408 to also access the same DMD or other DMD, i.e., if the DMD includes multiple video clips, the first user may establish rules that allow the second STB 404 to access certain video clips, while establishing different rules for other STBs to access other video clips. These rules can establish “buddy lists” that allow certain “buddies” (i.e., certain STBs) to access certain DMD while other buddies access different DMD.

ii. Sharing Digital Media Data Outside the Network

The STBs may also share DMD outside the first network 408. Specifically, the STBs may also share DMD to mobile devices external to the first network 408 and/or to STBs on other networks. As an example, the first network 408 may be in signal communication with the Internet 432 and a second network 434 through the Internet 432 and signal paths 436 and 438, respectively.

As an example, a first user at the first STB 402 may share DMD on the first STB 402 with a third user at a third STB 440. The third STB 440 may be in signal communication with the second network 434 via signal path 442 and may include a third renderer 444 and third storage device 446. The third STB 440 may also be in signal communication with a display device 448 to view the DMD. The second network 434 may be, for example, a second cable provider network. As an example, the first network 408 may be a Comcast cable network and the second network may be a Time Warner cable network.

As described above, the first user may capture video from the media device 416 at the first STB 402, which is processed to generate the DMD. Again as described above, the processing of the DMD may be accomplished by optionally utilizing the first renderer 418, the second renderer 424, the server renderer 428, other renderers (not shown) in other STBs (not shown) in signal communication with the first network 408, or any combination of these in parallel. Additionally, the DMD may be stored at the first storage device 420 and/or the server storage device 430.

The first user may allow the third user, through the third STB 440, to have access to the DMD stored on the first storage device 420 and/or server storage device 430, which may then be displayed on the display device 448. The first user may also allow other STBs (not shown) on the second network 434 to also access the same DMD or other DMD using buddy lists.

As another example, the first user at the first STB 402 may share DMD on the first STB 402 with a fourth user at a mobile device 450. The mobile device 450 may be in signal communication with the Internet 432 via signal path 452. The mobile device 450 may be a Internet 432 communication device having either wired or wireless connections to the Internet 432. The mobile device 450 may be, for example, an 802.11 enabled Apple iPod® device or other similar type of video device. Additionally, the mobile device 450 may be cellular mobile device such as a cellular telephone with video capability. If the mobile device 450 is a cellular mobile device, the signal path 452 may include a cellular network (not shown) that communicates between the mobile device 450 and the Internet 432.

Again, as described above, the first user may capture video from the media device 416 at the first STB 402, which is processed to generate the DMD. The processing of the DMD may be accomplished by optionally utilizing the first renderer 418, the second renderer 424, the server renderer 428, other renderers (not shown) in other STBs (not shown) in signal communication with the first network 408, or any combination of these in parallel. Additionally, the DMD may be stored at the first storage device 420 and/or the server storage device 430.

The first user may allow the fourth user, through the mobile device 450, to have access to the DMD stored on the first storage device 420 and/or server storage device 430, which may then be displayed on the mobile device 450. The first user may also allow other mobile devices (not shown) to also access the same DMD or other DMD using buddy lists.

Peer-to-Peer Buddy Lists

In general, a cable provider of the first network 408 maintains a domain name server on the first network 408, which may be the server 406 or another server (not shown). All the STBs on the first network 408 have machine access control (“MAC”) addresses, where each MAC address is a unique identifier assigned a specific STB that is used in the media access control protocol sub-layer. A new pathway to provide a more secure peer-to-peer transfer of shared DMD is a MACNS which links a MAC address to the domain name server (“MACNS”) this is a form of identity information. Generally, a domain name server is not truly secure and uses layer of software (variable) and identifiers such as the user name and/or password to authenticate. A MACNS uses multiple layers to secure that “sharee” STB and “sharer” STB (i.e., the peer 1 and peer 2) are in fact the parties whom believe each other are communicating with.

A third level of ID number or password may be layered over the MACNS as an option and this can be another form of identity information. Because cable providers may also maintain a Peer subscriber's current Internet protocol (“IP”) address (which can be dynamic), the MACNS may require filtering through the cable provider servers to update any IP address change.

i. Registering STB to Global Buddy List

A Peer signs on to register themselves to a Buddy list. Part of registration includes the inclusion of the peer's STB MAC address in a database managed by cable provider. The cable provider has a record of its subscribers MAC addresses and knows the DNS/IP address thereby forming the MACNS for Peer 1. The peer registration may include at least one of a “Handle” (aka a nickname), peer's actual name, billing telephone number and zip code for their STB service, cable provider name, receiver ID, cablecard id, access ID, STBserial number, etc.

Peer 1 may create a Buddy list (that includes other peers) that Peer 1 is authorizing for sharing and there may be degrees of authorization linked to different Buddies on the list (i.e. size of shared files, frequency, whether the file is automatically archived). Once a peer account is created, a peer-name and/or password may be provided and/or created to give Peer 1 remote access to the buddy lists.

ii. Finding a Buddy

Peer 1 (the sharer) wants to share with a specific Buddy (Peer 2) but Buddy is not already one of Peer 1's Buddies. Peer 1 is prompted by an STB menu to enter certain data criteria to identify Buddy (Peer 2). This may include any account registration information such as that type Peer 1 provided a CTP to create a peer's account.

The cable provider then takes the data provided by Peer 1 and conveys the data about Buddy (Peer 2) to Buddy's STB. Buddy's STB determines if Peer 1 has share rights to Buddy (Peer 2). If not the STB for Buddy notifies Buddy and requests authorization for Peer 1. If the STB for Buddy cannot authorize Peer 1 then no share. Otherwise sharing is supported. If Peer 1 is approved then STB for Buddy provides STB for Peer 1 Buddy's complete MACNS plus Buddy's active IP address.

Once Buddy is found, all relevant data is stored locally, including Buddy name, MACNS address for future authentication and current IP address (queried later to ensure validity, as IP addresses tend to be start by nature) when wanting to receive/transmit digital media. Once a Buddy is approved, Buddy's STB is authenticated and direct sharing from Peer 1 to Peer 2 at whatever approved level can commence.

iii. Managing Buddies and Lists

Buddy lists are listed by Peer 1, Peer 1 may add a preferred identifier. The following example is a non-exclusive list of some examples of such identifiers: age, location, attribute (female, male grandparent, siblings) image, group affiliation, nickname or full user name. Buddy lists can also be configured into groups or types of Buddies, depending on relationships.

Optionally, Peer 1 is able to set preferences to each Buddy individually vs. global settings. These specific preferences include, but not limited to:
File size—limit the amount of file size a Buddy can send per file. If file size is too large due to preferences, or exceeds available space the option to send a re-sized copy is optional.
File type—limit the typed of video codes acceptable (WM, MOV, H.264, Xvid, mpeg1, mpeg2, DV-AVI, Divx, MKV, and other known file formats and containers, including the native DVR file formats. Frequency how often per period a buddy can send Peer 1 DMD.

Content, files may be prescreened by Peer 1's DVR and files with questionable content (beyond a rating level i.e. family, teen, adult) may be refused or quarantined. Buddy if so chosen via preferences can be given direct, point to point access to both local STB content and/or to remote storage to view available content. Including publically available video or private content—determined by preferences relevant to the Buddy.

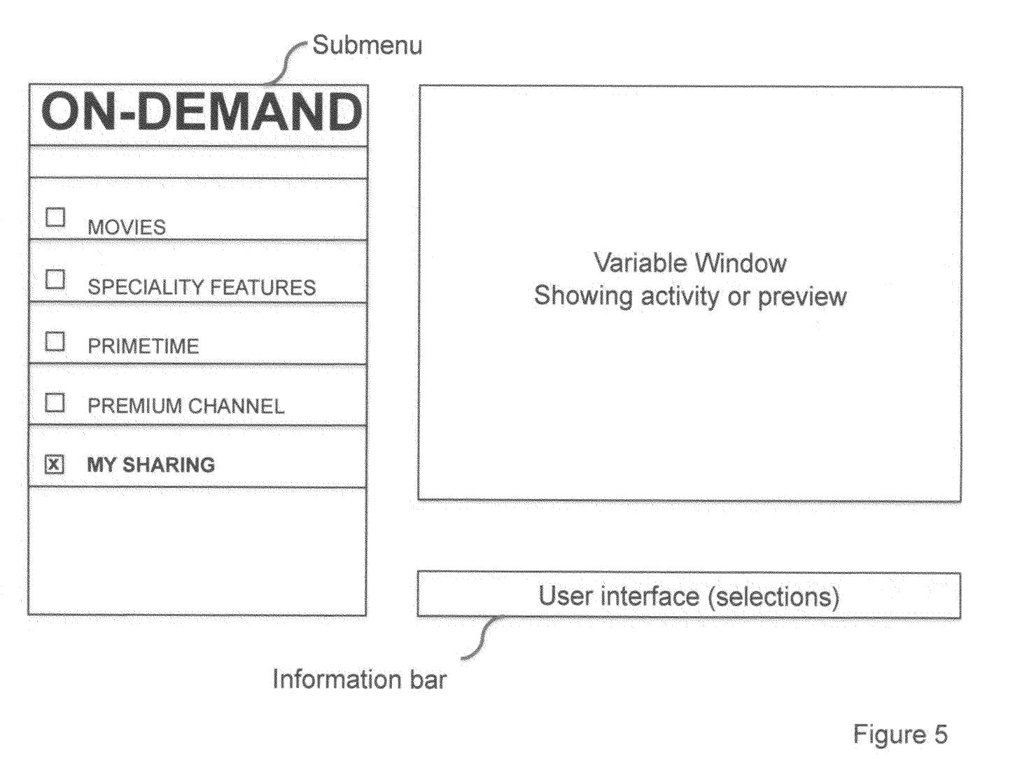

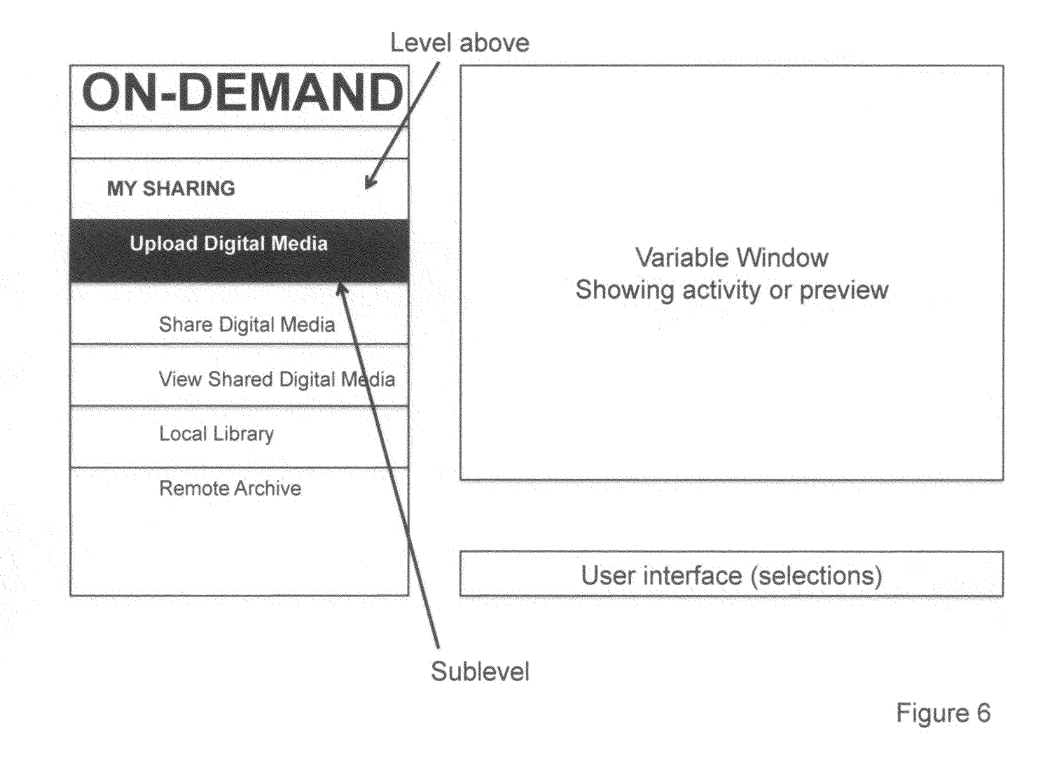

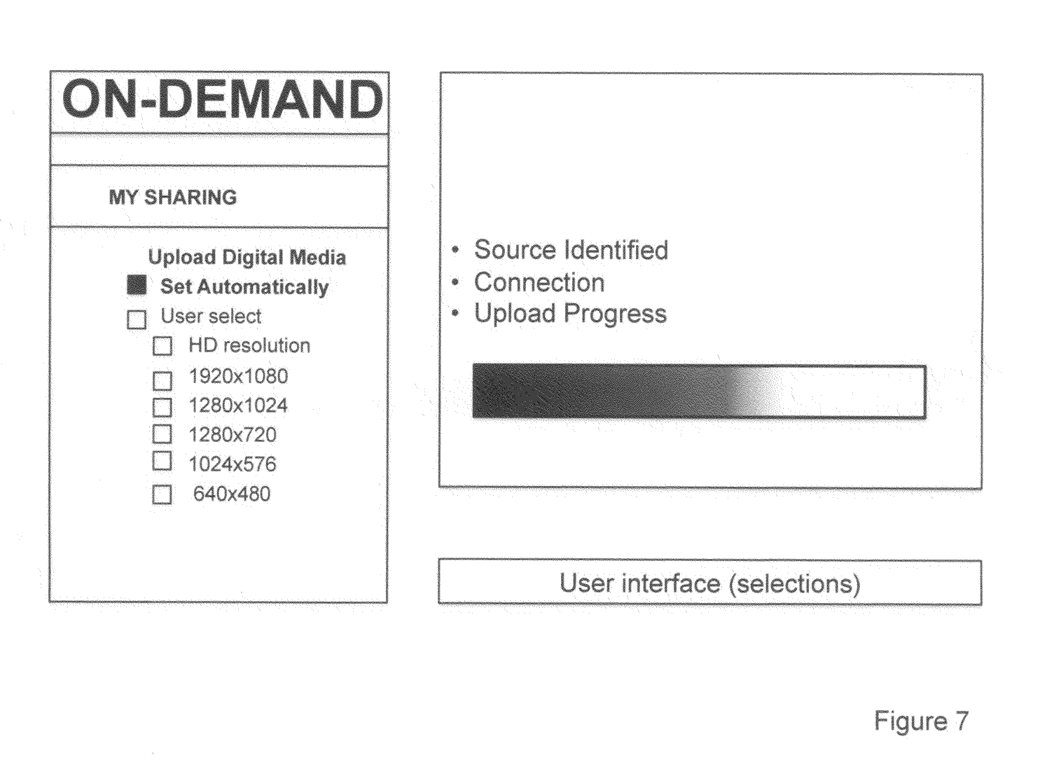

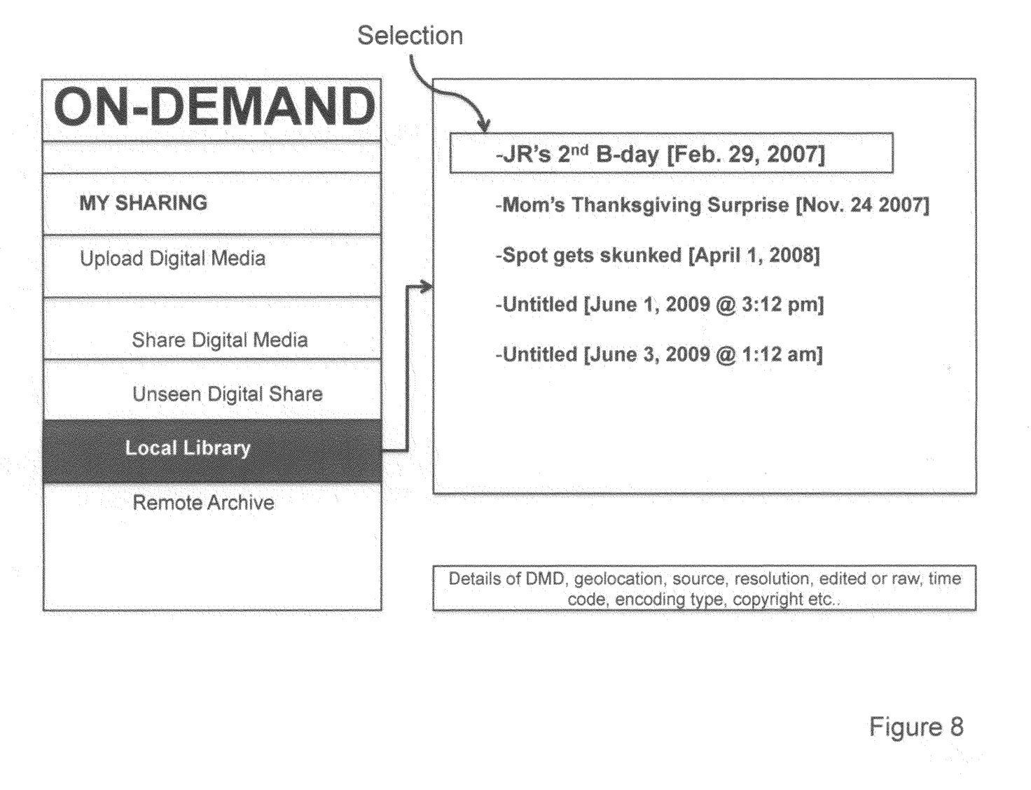

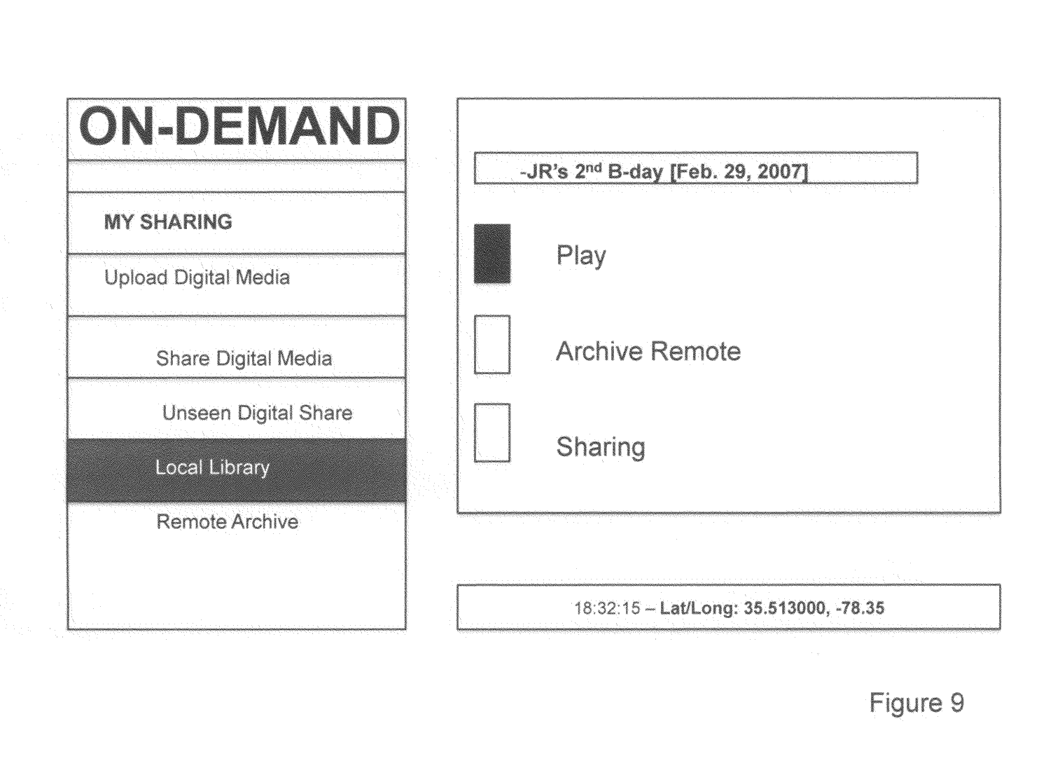

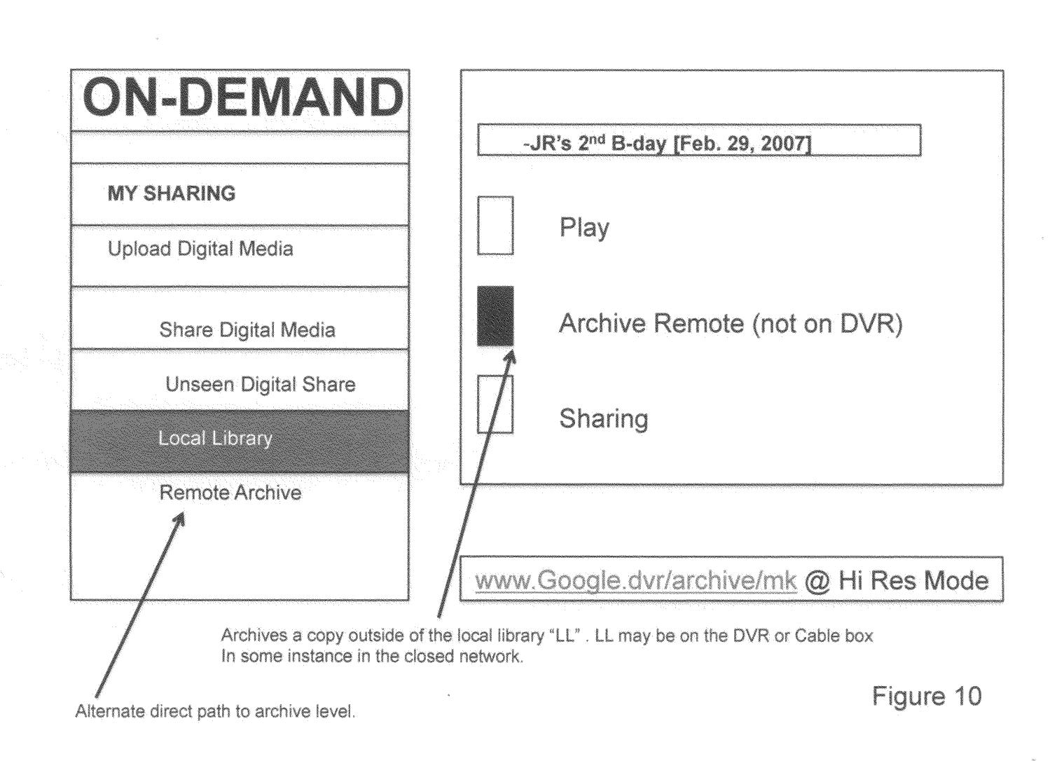

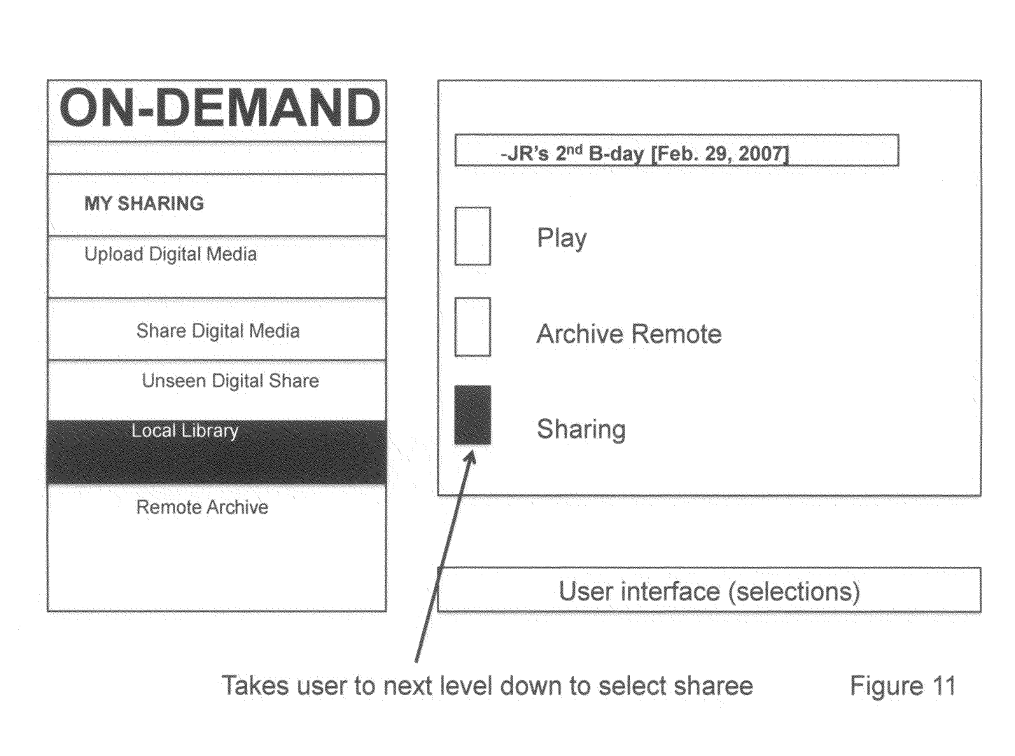

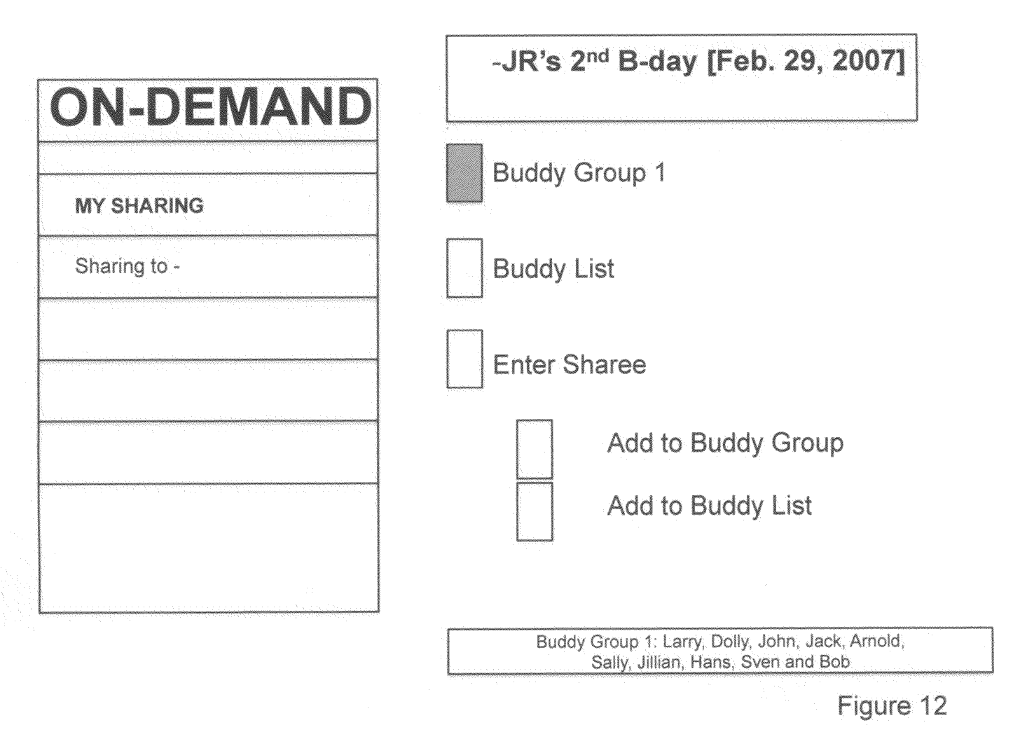

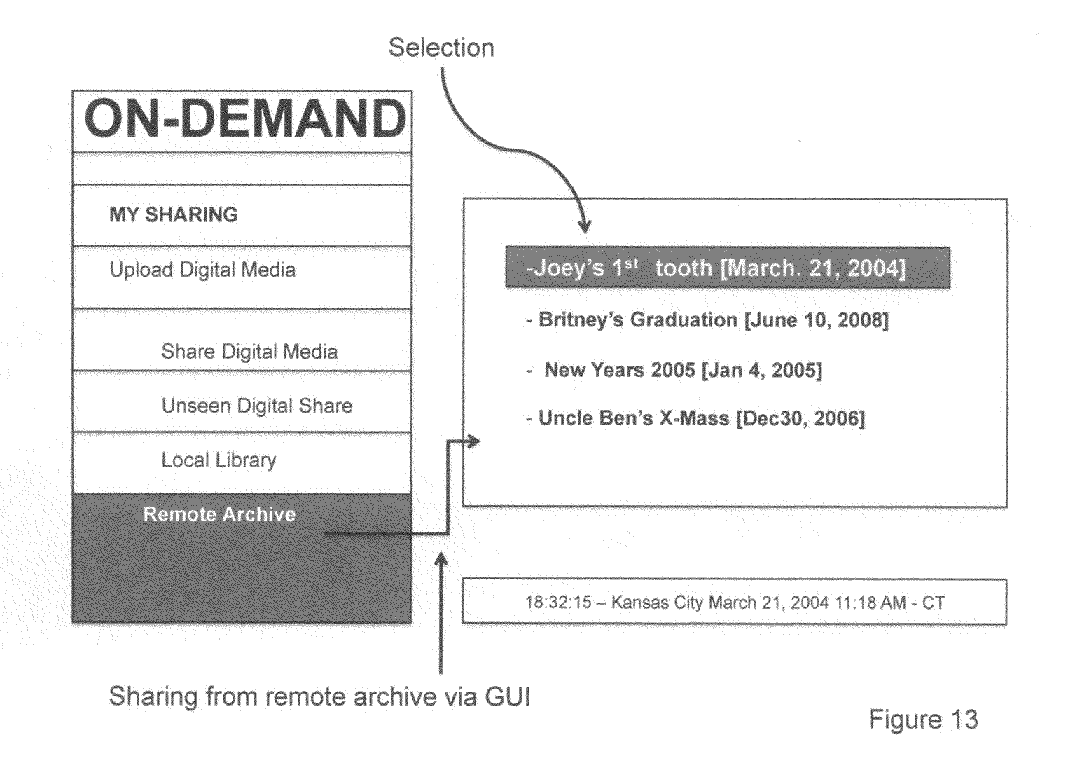

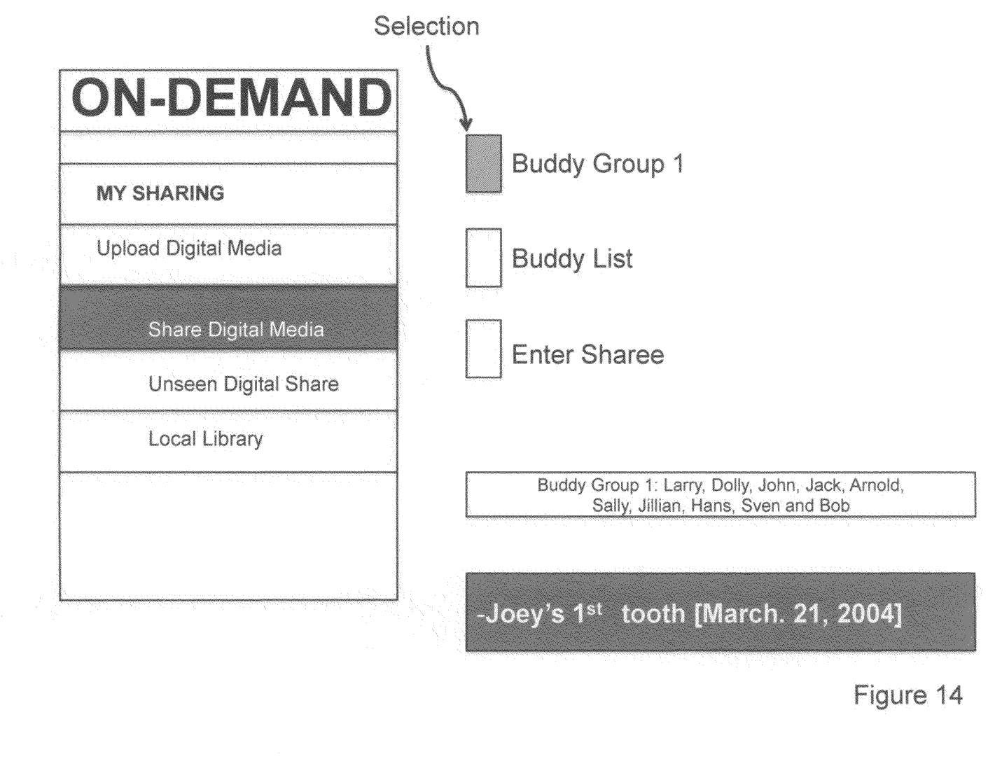

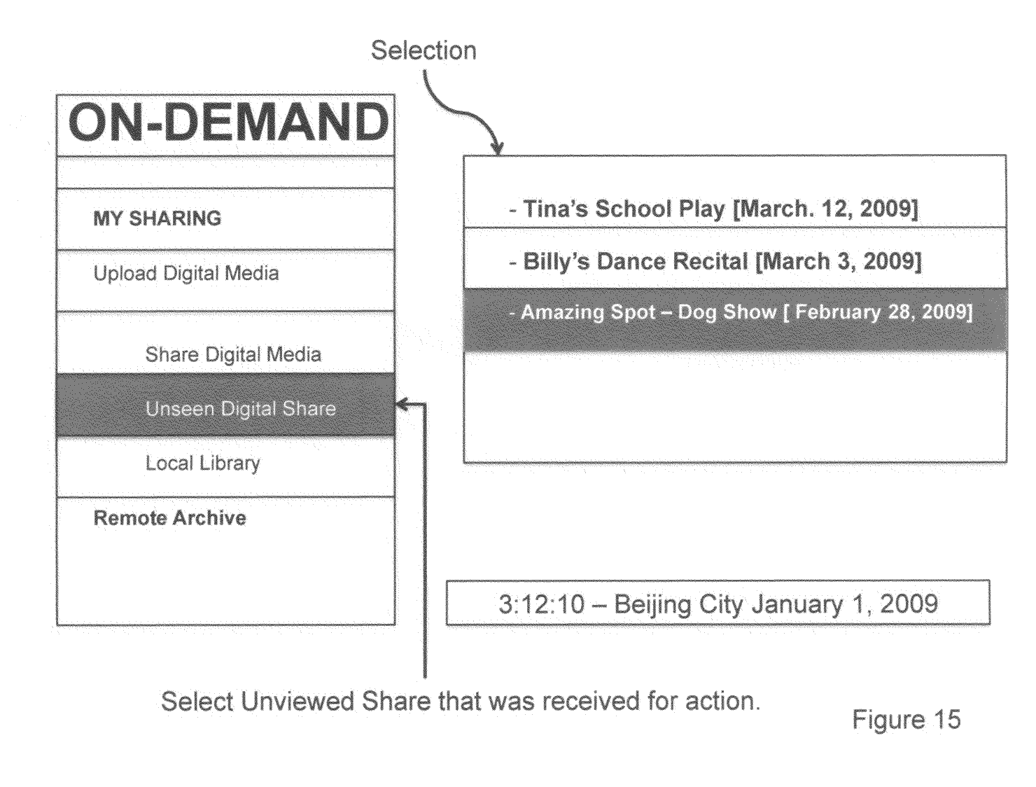

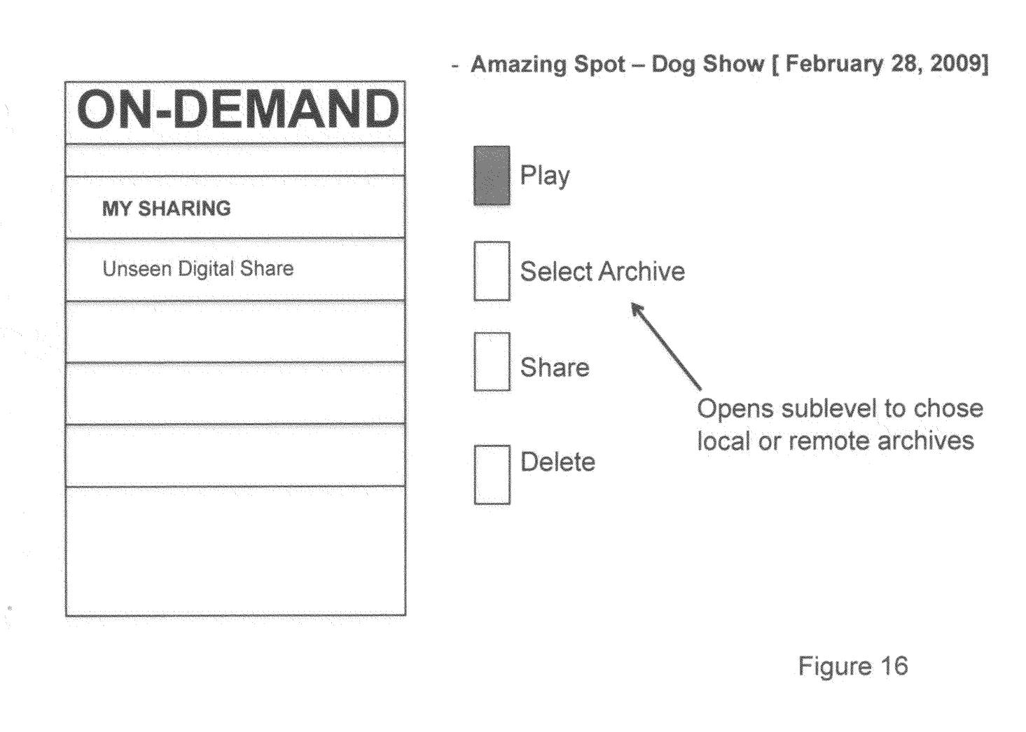

Shown in FIGS. 5 through 16 are example screen shots of a graphical user interface (GUI) to some aspects of the disclosure. All callouts in these figures are hereby incorporated as if fully set forth herein.

While the method and agent have been described in terms of what are presently considered to be the most practical implementations and aspects thereof, it is to be understood that the disclosure need not be limited to the disclosed implementations, aspects or order and/or sequence of combination of aspects. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the implementation, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting, such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternatives.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.
All callouts associated with figures are hereby incorporated by this reference.
Since certain changes may be made in the above system, method, process and or apparatus without departing from the scope of the disclosure herein involved, it is intended that all matter contained in the above description, as shown in the accompanying drawing, shall be interpreted in an illustrative, and not a limiting sense.

While various embodiments of the disclosure have been described, it will be apparent to those of ordinary skill in the art that many more embodiments and implementations are possible within the scope of this disclosure. Moreover, it will be understood that the foregoing description of numerous implementations has been presented for purposes of illustration and description. It is not exhaustive and does not limit the claimed disclosures to the precise forms disclosed. Modifications and variations are possible in light of the above description or may be acquired from practicing the disclosure. The claims and their equivalents define the scope of the disclosure. Accordingly, the disclosure is not to be restricted except in light of the attached claims and their equivalents.

What is claimed is:

1. A digital media sharing system (“DMSS”) for receiving digital media data produced by a media device, the DMSS comprising:
a network,
a first set-top box in signal communication with the network, wherein the first set-top box is configured to receive the digital media data from the media device;
a first rendering device in signal communication with the set-top box and the network, wherein the rendering device is configured to render the received digital media data; and
a storage device in signal communication with the set-top box and the network, wherein the storage device is configured to store the rendered digital media data.

2. The DMSS of claim 1, further including a second set-top box in signal communication with the network, wherein the second set-top box is configured to receive the rendered digital media data from the storage device.

3. The DMSS of claim 1, wherein the network is a cable communication network that is in signal communication with a plurality of set-top boxes.

4. The DMSS of claim 3, wherein the first rendering device is located within the first set-top box.

5. The DMSS of claim 4, wherein the storage device is located within the first set-top box and wherein the first rendering device is configured to render the received digital media data in a first file format optimized for the storage device.

6. The DMSS of claim 4, further including a server in signal communication with the cable communication network and wherein the storage device is external to the first set-top box and is in signal communication with the server.

7. The DMSS of claim 6, further including a second set-top box of the plurality of set-top boxes, wherein the second set-top box is configured to receive the rendered digital media data from the storage device.

8. The DMSS of claim 4, further including a second set-top box of the plurality of set-top boxes, wherein the second set-top box is configured to receive the rendered digital media data from the storage device.

9. The DMSS of claim 8, wherein the first rendering device is configured to render the received digital media data in a first file format for the storage device.

10. The DMSS of claim 9, wherein the first rendering device is configured to query the server for at least one file format usable by the storage device.

11. The DMSS of claim 4, further including a second rendering device located within a second set-top box of the plurality of set-top boxes.

12. The DMSS of claim 11, further including a server in signal communication with the cable communication network and wherein the storage device is external to the first set-top box and is in signal communication with the server.

13. The DMSS of claim 12, wherein the second set-top box is configured to receive the rendered digital media data from the storage device.

14. The DMSS of claim 12, further including a third set-top box of the plurality of set-top boxes, wherein the third set-top box is in signal communication with the network, and wherein the third set-top box is configured to receive the rendered digital media data from the storage device.

15. The DMSS of claim 3, wherein the first rendering device includes at least one processor.

16. The DMSS of claim 15, wherein the at least one processor is configured as a video encoder.

17. The DMSS of claim 16, wherein the processor is selected from a group consisting of a microprocessor, digital signal processor (“DSP”), application specific integrated circuit (“ASIC”), reduced instruction set computer (“RISC”) processor, central processing unit (“CPU”), graphics processing unit (“GPU”), visual processing unit (“VPU”), endec, codec, video codec, front-end processor, co-processor, and other similar types of processors.

18. The DMSS of claim 3, wherein the first set-top box is configured to produce an accessible menu on an display in signal communication with the first set-top-box.

19. The DMSS of claim 18, wherein the accessible menu displays confirmation of the storage of the rendered digital media data.

20. The DMSS of claim 1, wherein the first set-top box is configured to track the received digital media data from the media device and the stored rendered digital media data for usage billing.

21. The DMSS of claim 1, wherein the network is a cable communication network that is in signal communication with a plurality of set-top boxes, the DMSS further including a server in signal communication with the cable communication network, a second set-top box of the plurality of set-top boxes,
wherein the first rendering device is located within the first set-top box,
wherein the storage device is external to the first set-top box and is in signal communication with the server,
wherein the second set-top box is configured to receive the rendered digital media data from the storage device, and
wherein the first rendering device is configured to render the received digital media data in a first file format for the storage device.

22. A method for sharing digital media data produced by a media device over a network having a plurality of set-top boxes, the method comprising:
receiving the digital media data at a first set-top box of the plurality of set-top boxes;
rendering the received digital media data; and
storing the rendered digital media data on a storage device.

23. The method of claim 22, wherein the network is a cable communication network that is in signal communication with the plurality of set-top boxes.

24. The method of claim 23, wherein rendering includes rendering the received digital media data within at least the first set-top box.

25. The method of claim 24,
wherein storing including storing the rendered digital media data on a storage device located external to the first set-top box,
wherein the storage device is in signal communication with a server that is in signal communication with the cable communication network, and
wherein rendering includes rendering the received digital media data in a file format that is usable by the storage device.

26. The method of claim 25, further including producing and accessible menu that is displayed on a display in signal communication with the first set-top box, wherein the accessible menu displays a confirmation of the storage of the rendered digital media data.

27. The method of claim 23, further including receiving the rendered digital media data from the storage device at a second set-top box from the plurality of set-top boxes.

28. The method of claim 23, further including rendering the received digital media data within the first set-top box and a second set-top box of the plurality of set-top boxes.

29. The method of claim 28,
wherein storing including storing the rendered digital media data on a storage device located within the first set-top box and
wherein rendering includes rendering the received digital media data in a file format that is usable by the storage device.

30. The method of claim 29, further including producing and accessible menu that is displayed on a display in signal communication with the first set-top box, wherein the accessible menu displays a confirmation of the storage of the rendered digital media data.

31. The method of claim 28,
wherein storing including storing the rendered digital media data on a storage device located external to the first set-top box,
wherein the storage device is in signal communication with a server that is in signal communication with the cable communication network, and
wherein rendering includes rendering the received digital media data in a file format that is usable by the storage device.

32. The method of claim 31, further including producing and accessible menu that is displayed on a display in signal communication with the first set-top box, wherein the accessible menu displays a confirmation of the storage of the rendered digital media data.

33. The method of claim 32, further including querying the server for at least one file format usable by the storage device.

34. The method of claim 31, wherein storing the rendered digital media data includes establishing an archive for the rendered digital media data on the storage device.

35. The method of claim 28, further including establishing on the first set-top box access for the second set-top box to the stored rendered digital media data.

36. The method of claim 35, further including accessing the stored rendered digital media data with the second set-top box.

37. The method of claim 28, further including establishing on the first set-top box access for a sub-plurality of set-top boxes to the stored rendered digital media data.

38. The method of claim 37, further including accessing the stored rendered digital media data at the sub-plurality of set-top boxes.

39. The method of claim 24, further including establishing an archive for the rendered digital media data on at least one of the storage device and a remote archive.

40. A method for archiving shared digital media data produced by a media device over a cable communication network that is in signal communication with the plurality of set-top boxes, the method comprising:
receiving the digital media data at a first set-top box of the plurality of set-top boxes;
rendering the received digital media data within at least the first set-top box;
storing the rendered digital media data on a storage device;
utilizing a user interface of said first set-top box to one of selecting and establishing an archive for the rendered digital media data on at least one remote archive; and,
producing and accessible menu that is displayed on a display in signal communication with the first set-top box, wherein the accessible menu displays at least confirmation of the archive of the rendered digital media data.
